(19) United States
(12) Patent Application Publication
(10) Pub. No.: US 2015/0291827 A1
(43) Pub. Date: Oct. 15, 2015

(54) COATINGS, COMPOSITIONS, COATED ARTICLES AND METHODS

(71) Applicant: 3M INNOVATIVE PROPERTIES COMPANY, Saint Paul, MN (US)

(72) Inventors: Doo-Hyun Lee, Sydney (AU); Farhad Fattahi, Sydney (AU); Kui Chen-Ho, Woodbury, MN (US); Syud M. Ahmed, Minneapolis, MN (US); Kusum Gosain, Woodbury, MN (US); Yongshang Lu, Woodbury, MN (US)

(21) Appl. No.: 14/435,296

(22) PCT Filed: Oct. 24, 2013
(86) PCT No.: PCT/US13/66605

§ 371 Date: Apr. 13, 2015

(30) Foreign Application Priority Data
Oct. 24, 2012 (AU) 2012244167
Apr. 13, 2013 (AU) 2013205107

(51) Int. Cl. C09D 133/14; C09D 133/08; C09D 131/04; B05D 5/02; C09D 175/04

(52) U.S. Cl. CPC C09D 133/14; B05D 5/02; C09D 175/04; C09D 131/04; C09D 133/08

(57) ABSTRACT

Coatings for a surface, coating compositions, articles coated with a coating, and methods of coating are disclosed in which the coating comprises a polymer blend of polyurethane as a major component and at least one other polymer P2 having in comparison to polyurethane a higher peel strength to the surface to be coated, a higher percent elongation at break when cured, and a lower glass transition temperature, the polymer blend having been cured to form a peelable and flexible layer having a textured surface.

### FIELD OF TECHNOLOGY

This disclosure generally relates to coatings, compositions, articles coated with a coating, and methods of coating. In particular, it relates to coatings comprising a cured polymer blend that forms a peelable and flexible layer having a textured surface.

### BACKGROUND

Polymer-based slip resistant coatings for floor surfaces utilize various polymers to form coatings that can provide good surface friction. For example, epoxy-based coatings are commonly used on a wide variety of floor surfaces for providing slip resistance. Polyurethane coatings are widely used as floor coatings due to its high hardness and glossy appearance. However, due to its low surface friction, polyurethane coatings get slippery when wet. Various particulate materials may be added to such coatings to improve the friction between the coating and the contact surface established with a user walking over the surface. For example, U.S. Pat. No. 5,431,960 describes a coating containing particles that project upwardly from the base layer and assume an exposed position above the base layer.

Generally, the removal of worn out polymer-based coatings involves mechanical grinding or chemical stripping of the existing coating, which may be hazardous, costly and labor intensive. A need exists for slip resistant coatings that are removable easily and inexpensively, and provides good surface friction.

### SUMMARY OF INVENTION

In one aspect, there is provided a coating for a surface, comprising a polymer blend of polyurethane as a major component and at least one other polymer P2 having in comparison to polyurethane a higher peel strength to the surface to be coated, a higher percent elongation at break when cured, and a lower glass transition temperature, the polymer blend having been cured to form a peelable and flexible layer having a textured surface.

In another aspect, a coating composition for forming a peelable, flexible coating on a surface is provided, comprising a water-borne polymer dispersion that comprises polyurethane as a major component and at least one other polymer P2, polymer P2 having in comparison to polyurethane a higher peel strength to the surface to be coated, a higher percent elongation at break when cured, and a lower glass transition temperature, the polymer dispersion being curable to form a peelable and flexible layer having a textured surface.

In a further aspect, a method of coating a surface is provided, comprising the steps of providing a coating composition comprising a water-borne polymer dispersion that comprises polyurethane as a major component and at least one other polymer P2, polymer P2 having in comparison to polyurethane a higher peel strength to the surface to be coated, a higher percent elongation at break when cured, and a lower glass transition temperature, the polymer dispersion being curable to form a peelable and flexible layer having a textured surface; applying the coating composition over the surface to be coated; and curing the coating composition to form a peelable and flexible layer having a textured surface.

Another aspect is directed to coated articles. These and other aspects of the invention are described in the detailed description below. In no event should the above summary be construed as a limitation on the claimed subject matter which is defined solely by the claims as set forth herein.

### BRIEF DESCRIPTION OF THE DRAWINGS

Throughout the specification, reference is made to the appended drawings, where like reference numerals designate like elements, wherein:

FIG. 1A is a sectional view of a coating with textured surface applied to an article; FIG. 1B is a sectional view of a coating with textured surface and primer layer applied to an article; FIG. 1C is a sectional view of a coating with textured surface and primer layer applied to an article with a pre-existing coating layer; FIG. 1D is a sectional view of a coating with textured surface and particulate additives applied to an article; FIG. 1E is a sectional view of a coating with textured surface, particulate additives and primer layer applied to an article.

FIG. 2A shows a photograph of a magnified view of a coating with a coarse textured surface; 2B shows a photograph of a magnified view of a coating with a fine textured surface.

FIG. 3A to FIG. 3F show close-up photographs of various coated floor surfaces.

FIG. 4 shows a bar chart comparing the gloss values and slip resistance of different coatings.

FIGS. 5A and 5B show photographs of a surface coated with a conventional coating before and after slip resistance tests.

The figures are not necessarily drawn to scale. However, it will be understood that the use of a numeral to refer to a component in a given figure is not intended to limit the component in another figure labeled with the same number.

### DETAILED DESCRIPTION

Various aspects of the present disclosure provide for slip resistant coatings that are flexible and peelable, and have a textured surface for providing slip resistance. The textured surface results from the formation of cracks on the surface of the coating during the process of drying the coating. In other words, the present disclosure describes coatings in which crack formation is used as a means of increasing slip resistance in the coating. Additionally, the polyurethane-based coatings presently developed overcome shortcomings of poor adhesion and stiffness. These coatings provide an excellent peelable, flexible coating material that is adhesive yet peelable, and sufficiently flexible without cracking or flaking can be achieved, hence facilitating ease of removal. These coatings provide a means to protect surfaces from conventional wear and tear caused by direct contact, while advantageously enabling users to remove the coatings easily and inexpensively once the coatings are worn out, without the need for conventional chemical strippers or mechanical grinders or sanders. Furthermore, in various embodiments, the coating is a binder for particulate materials that serve various functions, such as slip-resistance under wet/damp conditions while maintaining its high gloss properties. Auxiliary properties such as anti-microbial properties, desiccating properties, etc. can also be achieved through the addition of suitable particulate materials.

The present specification is not limited to the specific examples or data set forth herein. The compositions, coatings and methods disclosed herein are capable of being made, practiced, used, carried out and/or formed in various ways expected of a skilled person in the field once an understanding of the invention is acquired. Numerical indicators, such as first, second, and third, as used in the description and the claims to refer to various structures or method steps, are not meant to be construed to indicate any specific structures or steps, or any particular order or configuration to such structures or steps. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification, and no structures shown in the drawings, should be construed as indicating that any non-claimed element is essential to the practice of the invention. The use herein of the terms “including” “comprising” or “having” and permutations thereof, is meant to encompass the features defined thereafter and equivalents thereof, as well as additional items.

Recitation of ranges of values herein are intended to refer individually to each separate value falling within the range, unless otherwise indicated herein, and each separate value is incorporated into the specification as if it were individually recited herein. For example, if a compositional range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this disclosure. Use of the word “about” to describe a particular recited amount or range of amounts is meant to indicate that values very near to the recited amount are included in that amount, such as values that could or naturally would be accounted for due to manufacturing tolerances, instrument and human error in forming measurements, and the like.

Unless otherwise stated, reference to any document herein does not constitute an admission that any of these documents forms part of the common general knowledge in the art. Any discussion of the references states what their authors assert, and the applicant reserves the right to challenge the accuracy and pertinency of any of the documents cited herein. All references cited herein are fully incorporated by reference, unless explicitly indicated otherwise.

In one aspect, the present disclosure provides a peelable flexible coating that comprises a polymer blend comprising polyurethane as a major component, and a polymer P2 having in comparison to polyurethane a higher peel strength to the surface to be coated as well as higher percent elongation at break when cured.

In this context, the term ‘blend’ refers to any form of polymer blend, including immiscible polymer blends (or heterogeneous polymer blends) having two glass transition temperatures, compatible polymer blends exhibiting macroscopically uniform physical properties due to sufficiently strong interactions between the component polymers, and miscible polymer blends (homogeneous polymer blend) observing a single-phase structure with one glass transition temperature. The term ‘peelable’ refers to the property of being removable by peeling. Peel strength is a measure of adhesive bond strength, and can defined by various measurements, such as the average load required to part two bonded materials per 25 mm separation, or the average load per unit width of bond line required to part two bonded materials where the angle of separation is 180 degrees and separation rate is 6 inches per minute (ASTM D-903). Percent elongation at break of a material refers to its strain at fracture, expressed as a percentage of its initial length. It is a measure of a material's flexibility in terms of how it will deform and strain when weight or force is applied, and may be expressed in terms of percent elongation at break as referenced throughout this application. By definition, flexible materials have a high percent elongation at break, and stiffer materials have a low percent elongation at break. In other words therefore, P2 is selected from a polymer that exhibits greater flexibility and higher adhesive bond strength to the surface to be coated than polyurethane.

In order to achieve a peelable coating, polymer P2 is selected from a polymer having a higher peel strength to the surface to be coated relative to polyurethane. The peel strength characteristics of polymer P2 is not fixed, but relative to the polyurethane present. In exemplary embodiments, polymer P2 has a peel strength of more than 5 N/25 mm, or more preferably more than 10 N/25 mm, or in some examples more than 20 N/25 mm or 25 N/25 mm, so that when blended with polyurethane, the coating achieves a peel strength greater than polyurethane alone, of between about 1 N/25 mm to 20 N/25 mm, or in some cases between 1 to 10 N/25 mm, or preferably between 20 N/25 mm and 25 N/25 mm. In some embodiments where the peel strength of the coating to the surface is sufficiently low, the act of peeling the coating can be carried out by hand manually. In other embodiments where the adhesion bond strength of the coating to the surface is high, peeling may be carried out with the aid of tools, or by incorporating peel tabs at various parts of the coating. In an exemplary embodiment, the peel strength (ASTM D1000) of the coating to the surface is about 10 N/25 mm or preferably about 5 N/25 mm. Referring to various technical literature, various 3M Scotch Weld polyurethane reactive adhesives or structural adhesives exhibit peel strengths commonly above 250-300 N/25 mm by comparison.

In order to achieve a flexible coating, polymer P2 has, in addition to the properties of higher peel strength, a higher percent elongation at break in comparison to polyurethane. Depending on the specific formulation, various polyurethane coatings may show elongation at break values of less than 25%, or less than 50%, or less than 100%. The modulus of polyurethane generally depends on polymer chain structure and interaction between polymer chains. For example, the chain length of diols used to react with diisocynates to form the polyurethane affects the modulus of the polyurethane. If long chain polyols are polymerized with diisocyante, flexible and elastic polyurethanes are formed, whereas short chain diols polymerized with diisocynate leads to less flexible and less elastic polyurethanes, for example. Hence, the elongation at break characteristic of polymer P2 is not fixed, but relative to the polyurethane present. In exemplary embodiments, polymer P2 has a percent elongation at break of more than 200%, or more preferably more than 500% elongation at break.

In order to achieve a textured surface in the coating, the overall glass transition temperature of the polymer blend and the minimum film formation temperature (MFFT) of the coating composition containing the polymer blend may be considered. Generally, the glass transition temperature of the polymer blend is formulated to be above room temperatures so that the polymer blend transitions to glassy state when left to cure at room temperature. For example, the polymer blend may be formulated to have a glass transition temperature of above about 10° C., or above about 30° C. or above about 50° C. In order to achieve this overall glass transition temperature in the polymer blend, the individual glass transition temperatures of polyurethane and polymer P2, and any other polymer P3 and so on added, may be considered. Polyurethanes generally have a wide range of glass transition temperatures. Depending on the chain length of diols used to react with diisocynates to form the polyurethane, selected polyurethanes may have glass transition temperatures ranging from less than −50° C., to more than 30° C. or more than 50° C. Exemplary polyurethanes for the present coating may have glass transition temperatures of above 0° C. or more commonly between about 10° C. to 50° C. The glass transition temperature of polymer P2 is not fixed, but relative to the polyurethane present. Correspondingly, polymer P2 has a lower glass transition temperature in comparison to the polyurethane present in the coating. In some embodiments, polymer P2 may be selected from a polymer having a glass transition temperature of lower than 25° C., or lower than 15° C., or preferably lower than 10° C., while the polyurethane has a glass transition temperature of between 10° C. to 50° C.

The MFFT is also a factor to be considered for the formation of a textured surface on the coating. The MFFT refers to the minimum temperature at which a water-borne synthetic latex or emulsion will coalesce when laid on a substrate as a thin film. The ASTM D2354-10e1 standard test method for MFFT of emulsion vehicles may be used to determine the MFFT of the present coatings. The standard explains that the satisfactory film integrity of emulsion coatings requires that as the aqueous phase evaporates, the resinous portion of the vehicle coalesces into a continuous film. MFFT is a factor in the process of film formation and the formation of cracks on the surface of the coating. To create crack patterns on the coating surface, the curing temperature is typically room temperature, and is typically lower than the overall glass transition temperature of the polymer blend. Without being bound to theory, it is understood that evaporation of water from water-borne dispersions containing the polymer blend of polyurethane and polymer P2, and so on, leads to the gradual coalescence of polymer particles, and as inter-polymer particle interaction increases, polymer particle deformation on the coating surface results in crack patterns being formed. By formulating the coating composition with a suitable MFFT and a polymer blend with a suitable glass transition temperature, the curing behavior and crack morphology on the coating surface can be tuned, which in turn enables the textured surface to be tuned in accordance with the slip resistance surface frictional requirements of the coating. In various embodiments, the coating composition has a minimum film formation temperature (MFFT) of generally above 30° C., or in some cases above 40° C. or above 50° C. Coating compositions having MFFT of less than 30° C. may still be provided the curing temperature is lower than the MFFT.

Generally, the textured surface has irregular surface structures, a morphology that may be characterized as crack structures defined by randomly coalesced polymer particles on the surface of the polymer blend. In some embodiments, the textured surface has a root-mean-square (RMS) surface roughness of between 0.1 μm to 20 μm, or more particularly between 1 μm to 5 μm. Due to the high coefficient of friction provided by the textured surface, the polymer blend may not require particulate additives, examples of which would include grit or polymeric beads conventionally used in slip resistant coatings and are larger than 30 μm. In some embodiments, particulate additives may be added for increased surface friction.

In various embodiments, P2 may be selected from polyesters, polyurethane-acrylates (PUA), polyacrylates, polyvinyl alcohol, polyvinyl acetate, acrylate modified polyolefins, and a combination thereof. Polymer P2 may also be selected from soft or elastomeric thermoplastic polyurethanes having soft segment domains having polyol/polyether/polyester linkages, blended with the major component of polyurethane with hard segment domains having urethane linkages. Generally, polymer P2 may be selected from polymers compatible with polyurethane, i.e., capable of homogeneous blending with polyurethane. Polyurethane and polymer P2 may both comprise a water dispersible polymer. Optionally, the film formation characteristics of polymer P2 may be considered. In other embodiments, P2 comprises a pressure sensitive adhesive (PSA) polymer. Examples of suitable PSA polymers include PSAs that contain elastomers such as acrylics, ethylene vinyl acetate, vinyl ethers and styrene block copolymers.

By blending polyurethane with a polymer P2 having the aforementioned properties, coatings formed becomes both peelable and flexible. In this manner, the coating may be formed as a single layer adhering directly to the surface to be coated, as no surface primer or intermediate adhesive layer or tackifier is required. The single layer coating may be formed through the application of one coat, or through the application of multiple coats. One coat may be suitable for forming a thin layer, whereas multiple coats of 2, 3, 4, or more coats successively may be suitable for forming a thick layer. In this regard, the coating thickness may range from a thin layer of 100 microns, or 10 microns, or less, to a thick layer of 1000 microns, or 10000 microns, or more. In some embodiments for floor coatings, the typical thickness of a coating ranges from 100 microns to 200 microns.

In some cases, pre-existing finish coatings on the surface to be coated may interfere with the adhesion between the peelable coating and the surface. Specifically, peelability issues may arise due to the different adhesion levels between the coating and the surface, leading to excessively high or low levels of adhesion between the coating and the surface. For example, floor substrates may have been coated with various floor finish coating products comprising polymeric materials such as acrylic polymers or polyurethane coating resins for floor protection. These various floor finish coatings can increase or decrease the peel strength of the peelable coating to be applied, hence affecting the peelable performance of the coating to be applied. In order to keep the peelable performance consistent regardless of pre-existing floor finish present, a primer coating layer may be added as an intermediate layer between the peelable coating to be applied and the pre-existing floor finish, i.e., in this embodiment, the coating further comprises a primer layer arranged between the coating and the surface. The primer layer provides a predictable interface for the peelable coating, so that consistent peelability or peel strength is achieved regardless of the floor finish coating present. Hence, in this context, the term “primer” as referenced in the term “primer coating layer”, herein also used interchangeably with the term “primer layer”, denotes a material that primes the surface to be coated by modifying, either by increasing or decreasing, the adhesion of the coating to the surface to a level that is suitable for the desired peelable performance.

In one embodiment, the primer layer comprises a release coating for decreasing the adhesion of the coating to the surface. The release coating may comprise surface active agents, such as polymers that have low surface energy, as exemplified by acrylic polymers and polyurethane polymers that are silicone or fluorine modified, or fluoropolymers which are synthesized from fluorinated monomers that have a certain degree of substitution of carbon chain hydrogen by fluorine. Polymer coatings that exhibit relatively low surface energy, such as paraffin, polypropylene, polyethylene and polytetrafluoroethylene (PTFE), may also be suitable as release coatings. Certain commercially available floor finishes may also be suitable for use as release coatings, such as 3M Scotchgard™ Vinyl Floor Protector, and other floor finishes exhibiting low surface energy, such as silane or fluoro containing compounds and polymers. In preferred embodiments, the primer comprises at least one of a fluorinated compound, fluoropolymer or fluorine modified polymer, an acrylic polymer, a polyurethane, a polyurethane acrylate, a silicone compound, a silicone modified polymer, paraffin wax, polypropylene wax, polyethylene wax, and mixtures thereof.

The adhesion peel strength of the peelable coating to the floor surface may also be tuned to a desired range by incorporating surface active materials, particularly low surface energy additives, directly into the coating, without using a primer layer, or optionally, in combination with a primer layer as described in the foregoing paragraphs. For example, low surface energy polymers similar to those used for the primer layer may be added as an adhesion modifying additive to the peelable coating, or alternatively to the floor finish. Other examples of suitable low surface energy materials include polymeric fluorochemical surfactants such as 3M Novec™ fluorosurfactants, silicone polyethers available from Dow Corning Inc., low tack adhesives such as styrene/acrylic acid copolymer microspheres, and hexafluoropropylene oxide (HFPO).

In another embodiment, the primer layer comprises an adhesion promoter for increasing the adhesion of the coating to the floor surface. This may be useful in cases where the surface to be coated contains low surface energy materials, such as polypropylene, polyethylene, polytetrafluoroethylene (PTFE), or have resins/oil/wax from the floor timber accumulating on the surface over time, for example. In other examples, the primer layer is an interface or intermediate layer serving other functions than adhesion modification, such as a primer layer functioning as a protective layer (e.g., a polycarbonate primer layer), or as a backing to enable the peelable layer to be cohesively detached from a substrate surface, or a coloring layer, for example.

In one embodiment, the coating is formed from a plasticizer-free coating formulation. By being plasticizer-free, it is meant that the coating is at least substantially, or totally, free of conventional plasticizers used to increase the plasticity or fluidity of the coating composition. In the case of polyurethanes, phthalate-based plasticizers such as di-isooctyl phthalate (DIOP) or other phthalate esters have been commonly used plasticizers. The absence of such compounds renders the coating composition plasticizer free. Phthalate-free formulations are desirable because of the documented harmful effects of phthalates on the human body. The presence of minute or trace quantities of such plasticizers, such as a content of less than 0.1% by weight, or more preferably less than 0.01% by weight, may inadvertently be present and may be considered essentially plasticizer free.

In some embodiments, the coating further comprises a third polymer P3 having higher peel strength to the surface to be coated and/or higher percent elongation at break than polymer P2 when cured. Similarly, the peel strength and elongation at break characteristics of polymer P3 is not fixed, but relative to the polymer P2 present. Polymer P3 may be provided as an adhesion and modulus modifier to complement P2, compensating for weak adhesion or high modulus properties in P2. The addition of a third polymer P3 may be used to achieve coating properties that are unachievable through the combination of polyurethane and polymer P2 alone. For example, P3 may be selected from a polymer that on its own forms a very soft & flexible film when cured. In other embodiments, the coating further may comprise a third polymer P3 having a lower glass transition temperature than polymer P2 when cured. Polymer P3 may be provided to lower the overall glass transition temperature of the polymer blend, compensating for high glass transition temperature properties in P2 and/or polyurethane, for example.

In one example, polymer P2 has higher peel strength than polyurethane but percent elongation at break that is similar or marginally higher than polyurethane, and polymer P3 is selected from polymers having higher percent elongation at break than P2, hence compensating for the low flexibility of P2. In another example, polymer P2 has higher percent elongation at break than polyurethane but similar or marginally better adhesion to a specified substrate, and a third polymer P3 which provides better adhesion to the substrate than P2, hence compensating for the low peel strength of P2. Hence, polymer P3 may be selected to compensate for poor peel strength and/or poor flexibility of polymer P2. Depending on the properties of P2 that require compensating, P3 may be selected from polymers that exhibit greater than 700%, or 1000% elongation at break, and high peel strength of greater than 25 N/25 mm, or greater than 30 N/25 mm.

P3 may also be selected from polymers having other properties such as chemical resistance and thermal resistance, or to modify the minimum film formation temperature (MFFT) the glass transition temperature of the polymer blend, or to modify the glass transition temperature of the polymer blend. In one embodiment, P3 comprises a polymer having MFFT of about 0° C. or less, and a glass transition temperature substantially similar to the minimum film formation temperature. This enables film formation at room temperature. In one example, P3 comprises a polymer having a combination of MFFT of less than 0° C. and 1000% elongation at break to facilitate film formation without co-solvent added and to impart flexible properties to the cured coating.

In embodiments of coatings comprising polyurethane and polymer P2, the following illustrative compositional ranges may be used: the coating may comprise 60% to 90% by weight of polyurethane and 10% to 40% by weight of polymer P2 (dry solid content). In an exemplary embodiment, polymer P2 comprises polyacrylate present in an amount such that the weight ratio of polyurethane to polyacrylate in the coating is between 1 to 10. In another exemplary embodiment, polymer P2 comprises polyurethane with soft segment domains having polyol/polyether/polyester linkages, blended with polyurethane with hard segment domains having urethane linkages. In accordance with the foregoing, the coating may comprise any of the following compositional combinations: (i) 60% polyurethane+40% polyurethane-acrylates, (ii) 70% polyurethane+30% polyacrylates, (iii) 80% polyurethane+20% polyurethane, (iv) 90% polyurethane+10% polyvinylalcohol. Other possible combinations include the following: (i) 70% polyurethane comprising hard segment domains (e.g., using short chain length diol monomers) having urethane linkages covalently coupled to 30% polyurethane comprising soft segment domains (e.g., using long chain length monomers) having polyol/polyether/polyester linkages, (ii) 70% polyurethane+30% polyacrylate, (iii) 70% polyurethane+30% polyurethane-acrylate, (iv) 60% polyurethane+20% polyurethane+20% polyurethane-acrylate, (v) 70% polyurethane+30% polyvinyl acetate.

In embodiments comprising polyurethane, polymer P2 and polymer P3, the coating may comprise 60% to 90% by weight of polyurethane, 5% to 30% by weight of polymer P2, and 5% to 30% by weight of polymer P3. For example, the coating may comprise any of the following compositions: (i) 60% polyurethane+30% polyurethane-acrylates+10% polyvinylacetate; (ii) 70% polyurethane+20% polyacrylates+polyesters.

In a preferred embodiment, the coating further comprises particles distributed or dispersed in the polymer blend. The polymer blends of polyurethane and polymer P2, and optionally polymer P3, as described above provide a convenient peelable, flexible matrix for holding various types of particulate materials that serves various functions. Examples of contemplated particulate materials include polymeric particles, desiccants, fire retardants, antifouling materials, disinfectants, ultraviolet absorbing materials, heat absorbing materials, photocatalysts, aromatic compounds, insecticides, color pigments, reflective materials and high refractive index materials.

In one embodiment, the particulate materials comprise slip resistant granules (or particles). The addition of slip resistant granules gives rise to slip resistant floor coatings that provide increased traction & slip resistance that the polymeric coating alone may not be able to achieve. Slip resistant granules may comprise an organic selected from the group consisting of polyolefin, polyacrylate, polyester, nylon, polycarbonate, polyoxymethylene, fluoropolymer, styrene, and polyurethane. Slip resistant granules may comprise thermoplastic polyolefins such as polyethylene (PE), polypropylene (PP), polymethylpentene (PMP), polybutene-1 (PB-1); as well as polyolefin elastomers such as polyisobutylene (PIB), Ethylene propylene rubber (EPR), ethylene propylene diene monomer (M-class) rubber (EPDM rubber).

In a preferred embodiment, slip resistant granules comprise Polypropylene (PP) granules. PP granules can be purchased inexpensively. They were found to provide good compositional stability due to its density and non-polar nature. When cured, polypropylene granules were found to provide high slip resistance, as well as similar refractive index to the polyurethane of about 1.4 to 1.5, which can help maintain the high gloss on the coating surface. Its low density of 0.8 g/cc at 25° C., can improve the storage stability of the final coating product without precipitation. Also, the blocky shape of polypropylene granules helps to prevent injury in the event of fall/slip accident. In exemplary embodiments, the coating may be formed using a coating composition comprising between 1% to 10% by weight of polypropylene granules, or preferably between 1% to 5% by weight of polypropylene granules.

Slip resistant granules may also comprise inorganic materials selected from the group consisting of calcium carbonate, talc, barytes, clays, silicas, titanium dioxide, carbon black, organo-clay, alumina, and carbon nanotubes, glass bubbles, silicon carbide, quartz, cerium oxide, silica, ceramic particles, and ground minerals. Other types of materials such as ionomers, rubber particles, core-shell particles, or engineering plastic polymers with high temperature resistance such as polyether ether ketone (PEEK) and polyethersulfone (PES) may be used to achieve slip resistance.

The slip resistant granules may have a size of between 10 to 1000 microns, or in exemplary embodiments, between 30 to 400 microns. A combination of large particles and small particles, as illustrated in the figures, may also be used. In some embodiments, the particles are selected to be of a size that is less than the thickness of the coating to be applied. Where high slip resistance is required, large particles that exceed coating thickness may be selected in order for the particles to protrude from the coating, thereby providing greater surface contact for increasing contact friction. Beyond a certain size threshold, the particles may cause the coating to lose its glossy appearance due to the lower light scattering ability of the larger particles. Hence, an optimal range exists where an acceptable balance between slip resistance and glossiness may be achieved, if glossiness is a consideration. In one embodiment, this optimal range occurs with formulations that comprises particles with a size of between about 60 to 200 microns. Such a formulation can exhibit slip resistance of at least 20 BNP, or at least 25 or more preferably at least 30 BNP, as tested by the British Pendulum Slip Resistance Tester under wet conditions, and gloss of at least 20 GU, or at least 30 GU, or at least 40 GU, or more preferably at least 50 GU at 60° as measured by a standard glossmeter (ISO 2813).

Base additives may be present in the coatings to achieve the necessary physical or chemical properties required in a specific application. As described below, base additives may be added to the liquid coating composition before application to the surface to be coated. The additives may comprise volatile compounds that vaporize away during the curing of the coating, or it may comprise non-volatile compounds that stay in the coating after curing. Where polymer P2 is selected to form a partially immiscible blend with polyurethane, polar or partially polar organic co-solvents may be added to enable miscibility between the polymers present. Rheology modifiers may be added to control the viscosity of the composition. For example, a specific application may require the composition to be sufficiently viscous to appropriately suspend slip resistant particles in the composition. Thus, the viscosity of the composition should facilitate uniformly loading the particles on an applicator prior to actual application. It may also be important that the viscosity of the composition be such that the composition does not excessively flow when being applied but permits an applicator to control the final thickness of the resulting floor coating. Further examples of base additives include defoamers, leveling agents, and organic wax emulsions. To provide the coatings with additional functionalities, additives such as biocides, pigments, fillers, colorants, dyes, anti-cratering agents and anti-sagging agents may also be added to the coating.

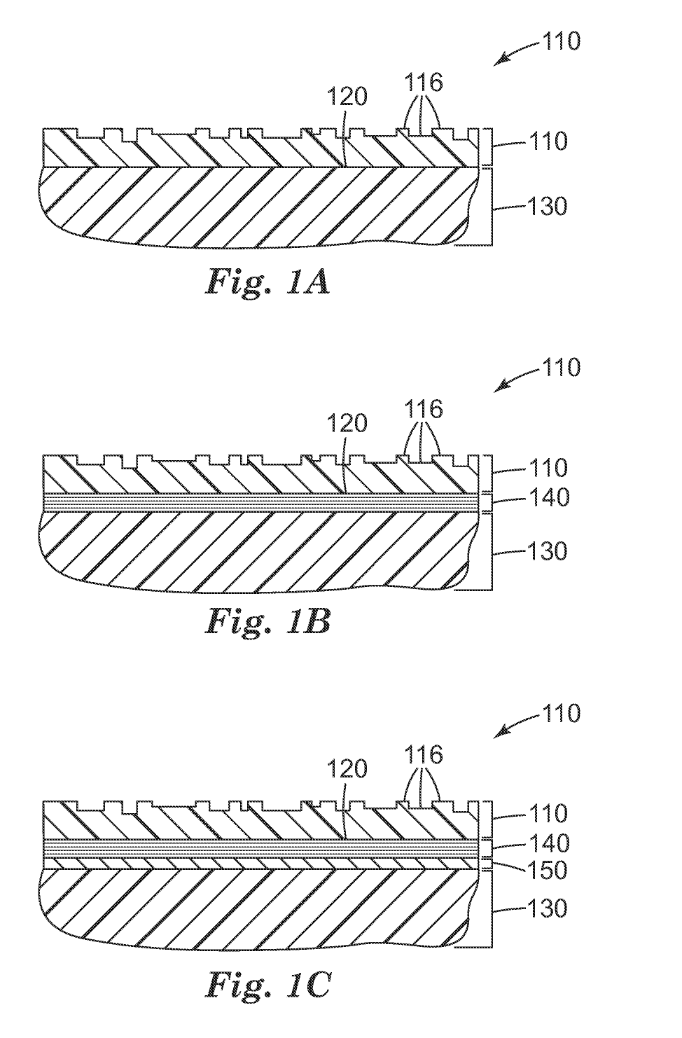

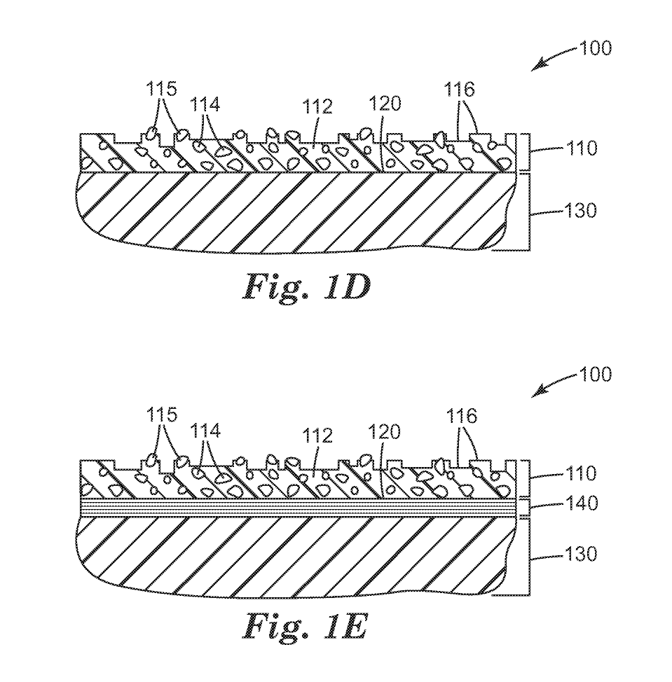

Referring to FIG. 1A, there is shown a cross section of a coated surface 100. Coating 110 is formed directly on the surface 120 of an item 130 to be coated. Coating 110 comprises a polymer blend, which on curing, forms cracks 116 of various irregular sizes randomly distributed across the surface of the coating 110. In some embodiments, a layer of primer may be applied to the surface to be coated, such as when the item to be coated the coating 110 may be formed on surfaces with pre-existing coatings which may have been in use and is worn out. FIG. 1B shows a cross section of another coated surface 100. A layer of primer 140 is formed on the surface 120 of the item 130, after which the coating 110 is then formed on the layer of primer 140. FIG. 1C shows a cross section of yet another coated surface 100 that has a pre-existing coating 150. A layer of primer 150 is formed on the pre-existing coating 150, after which the coating 110 is then formed on the layer of primer 150.

FIGS. 1D and 1E illustrate examples of particulate additives used in conjunction with textured surface coatings. FIG. 1D shows a cross section of a coated surface 100. Coating 110 is formed directly on the surface 120 of an item 130 to be coated. Coating 110 comprises a polymer blend that serves as a matrix 112 for particulate additives, and which on curing, forms cracks 116 of various irregular sizes randomly distributed across the surface of the coating 110. Slip resistant particles are dispersed throughout the matrix 112. In this figure, the particles 114 have a diameter that is smaller than the thickness of the coating 110, hence they remain largely embedded within the coating 110. Some surface particles 115 may randomly be present at the surface 116. The amount of surface particles 115 may be increased with the use of larger quantities of particles 114 in order to increase the coefficient of friction of surface 116 of the coating 110, as compared to the coefficient of friction of surface 116 comprising only cracks 116 for frictional enhancement. FIG. 1E shows a cross section of another coated surface 100 where a layer of primer 140 may be interposed between the coating 110 and the surface 120. The primer layer may be used to modulate the adhesion between coating 110 and the surface 120, for example.

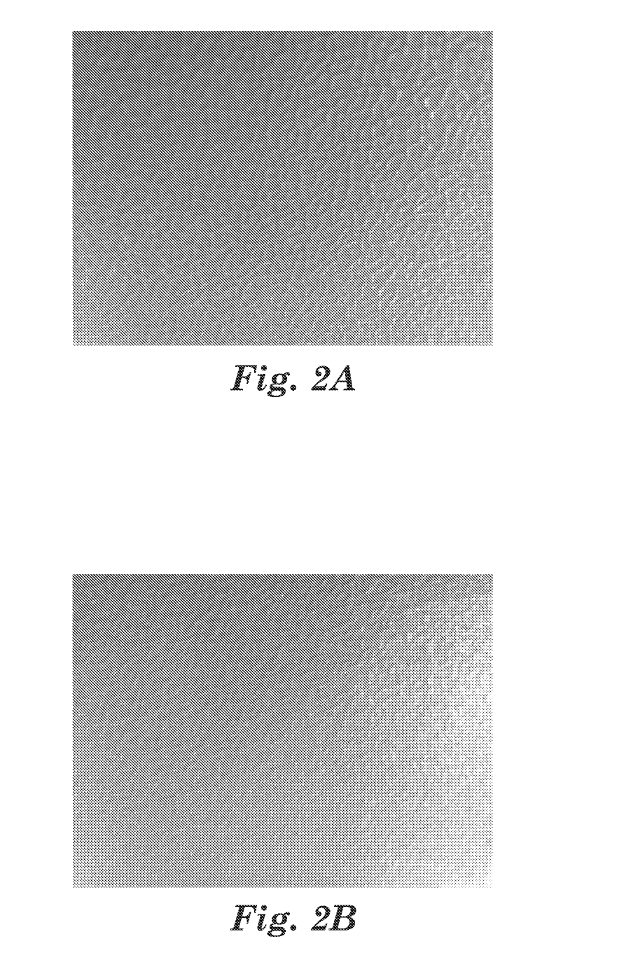

Different crack patterns are achievable through the use of different combinations of polymers having differing characteristics. FIG. 2A shows a magnified view of the surface of a coating having large crack patterns, while FIG. 2B shows a magnified view of the surface of a coating having fine crack patterns. Generally, polymer blends comprising polymers having high elongation at break characteristics (i.e., low modulus, flexible) cured to form small-sized, fine crack-patterns on the surface where the cracks appeared to be disconnected/separated. Polymer blends comprising polymers having low elongation at break characteristics (i.e., high modulus, stiff) cured to form large sized and well connected crack patterns.

In another aspect, a coating composition is provided. The coating composition comprises a water-borne polymer dispersion that comprises polyurethane as a major component and at least one other polymer P2, polymer P2 having in comparison to polyurethane a higher peel strength to the surface to be coated, a higher percent elongation at break when cured, and a lower glass transition temperature. The polymer dispersion is curable to form a peelable and flexible layer having a textured surface.

The term ‘dispersion’ in this context conforms to the definition in the IUPAC Compendium of Chemical Terminology (2007), which defines a dispersion to be a material comprising more than one phase, where at least one of the phases consists of finely divided phase domains, often in the colloidal size range, distributed throughout a continuous phase domain. The water-borne polymer dispersion may be obtained by mixing a first polymer dispersion D1 comprising a water-based polyurethane dispersion (PUD), such as commercially available polyurethane dispersions from Dow (e.g., SYNTEGRA® polyurethane dispersions) or from Bayer (e.g., Bayhydrol® aqueous polyurethane dispersions, or Dispercoll® aqueous polyurethane dispersions), for example, with a second water-based polymer dispersion D2 comprising polymer P2. P2 is selected from a polymer having, in comparison to polyurethane, a higher peel strength to the surface to be coated, a higher percent elongation at break when cured, and a lower glass transition temperature. D2 may comprise any suitable water-based polymer dispersion compatible for blending with D1. Commercially available dispersions for polyesters, polyurethane-acrylates (PUA), polyacrylates, polyvinyl alcohol, polyvinyl acetate, acrylate modified polyolefins may be identified by various trade names, such as BASF (e.g., Acronal® aqueous polyacrylate dispersions) or Bayer (e.g., Bayhaydrol A® aqueous polyacrylate dispersions) or DSM (e.g., NeoCryl® acrylic copolymer dispersions or NeoPac® polyurethane-acrylate dispersions) or Bayer (e.g., Bayhdrol® E aqueous polyester dispersions) or Achema (e.g., PVAD® polyvinyl acetate dispersions) or Nuplex (e.g., Acropol® polyvinyl acetate dispersions). In exemplary compositions, the polymer content of the composition comprises 50% to 90% by weight of polyurethane and 10% to 50% by weight of polymer P2.

A third polymer dispersion D3 comprising polymer P3, as described in the foregoing paragraphs, may also be used in the coating composition if it is desired to include polymer P3 into the coating to modify the characteristics of the coating. D3 may comprise a water-based polymer dispersion compatible for blending with D1 and D2. In preferred embodiments, polymer P3 has a lower glass transition temperature than polymer P2. In exemplary embodiments, the polymer content of the composition comprises 60% to 90% by weight of polyurethane, 5% to 20% by weight of polymer P2, and 5% to 20% by weight of polymer P3.

Due to the ability of the coating to form a textured surface upon curing, the coating composition may not require particulate additives for forming protrusions on the surface of the cured polymer blend to enhance surface friction, although some embodiments may use such particulate additives. If particulate additives are used, the coating composition may include any of the aforementioned particles.

The coating composition may further comprise an isocyante curing agent. Other curing agents include aziridines and carbodiimides, which serve as crosslinkers to the polymers present in the polymer blend.

Polar organic co-solvents may be used in the coating composition to bring polyurethane and polymer P2, and optionally polymer P3 into a common phase. Coalescents may also be used for increasing the glass transition temperature of the polymer blend. Coalescents and polar organic solvents may be selected from various polar organic compounds, such as butoxydiglycol, butyl glycol, glycol ethyl ether and DEG ethyl ether (ethyl ether, alkylene glycol ethers such as ethylene glycol monomethyl ether, ethylene glycol monohexyl ether, ethylene glycol monoethyl ether, ethylene glycol mono-n-butyl ether, diethylene glycol monomethyl ether, diethylene glycol mono-n-butyl ether, propylene glycol monomethyl ether, dipropylene glycol monomethyl ether, tripropylene glycol monomethyl ether, ethylene glycol monoisobutyl ether, diethylene glycol monoisobutyl ether, propylene glycol monoisobutyl ether, ethylene glycol monophenyl ether, propylene glycol monophenyl ether, ethylene glycol monomethyl ether acetate, and mixtures thereof.

The coating composition may comprise total solid polymer content of between 20% to 60% by weight of the composition. In typical embodiments, the solid content is about 30% to 45%. The ratio of polyurethane to polymer P2 may vary between 80% to 90% by weight of polyurethane and 10% to 20% by weight of polymer P2. Where polymer P3 is present in the coating composition, the ratio of polyurethane to polymer P2 and P3 may vary between 80% to 90% by weight of polyurethane, 5% to 10% by weight of polymer P2, and 5% to 10% by weight of polymer P3, for example.

In a further aspect, a method is provided to form the coating. The method comprises the steps of providing a first polymer dispersion D1 comprising polyurethane, providing a second polymer dispersion D2 comprising a polymer P2 having in comparison to polyurethane a higher peel strength to the surface to be coated and a higher percent elongation at break than polyurethane when cured, and blending D1 and D2 at standard ambient temperature and pressure. Quantities of D1 and D2 are provided such that polyurethane is a major component and P2 is a modifier for imparting a flexible and peelable quality to the coating.

The blend of D1 and D2 may be further blended with particulate materials, such as slip resistant granules. It may also be mixed with various base additives such as polar or partially polar organic co-solvents, rheology modifiers, defoamers, leveling agents, and organic wax emulsions, biocides, anti-sagging agent, anti-cratering agent, color dyes, and combinations thereof. Where it is desired to introduce a third polymer P3 as an adhesion and modulus modifier into the coating composition, the blend of D1 and D2 may be further mixed with a third polymer dispersion D3 comprising a polymer P3. Polymer P3 may have higher peel strength to the surface to be coated and/or higher percent elongation at break when cured than polymer P2, for example.

In one embodiment, the step of mixing particulate materials to the composition may be carried out as a last step, after the blending of polymer dispersions D1, D2 is carried out. To achieve a good distribution of the particles within the polymer blend, stirring is carried out until an even distribution of particles is achieved. This may be carried out under moderate stirring of 300 to 500 rpm for 5 minutes or more, for example.

In a yet further aspect, a method of coating a surface is also provided. The method comprises the steps of providing a coating composition comprising a water-borne polymer dispersion that comprises polyurethane as a major component and at least one other polymer P2, polymer P2 having in comparison to polyurethane a higher peel strength to the surface to be coated, a higher percent elongation at break when cured, and a lower glass transition temperature, the polymer dispersion being curable to form a peelable and flexible layer having a textured surface; applying the coating composition over the surface to be coated; and curing the coating composition to form a peelable and flexible layer having a textured surface.

In one embodiment, the composition is cured by drying the composition at an ambient temperature that is below the glass transition temperature of the polymer blend. In some embodiments, the glass transition temperature of the polymer blend is above 50° C., or preferably above 30° C.

The applicator may comprises a mop, a brush, a roller or a steel spreader, optionally with the aid of a squeegee. In some embodiments, between 0.05 to 1 liter of coating composition is applied per squared meter of surface to be coated, depending on the thickness of the coating to be applied. The volume of coating composition may be applied over a single coat, or over several consecutive coats. Curing the coat is necessary to allow volatile solvents to vaporize, thereby enabling the polymers present in the composition to phase change into a hardened state. In some embodiments, the glass transition temperature (‘T_{g}’) of the polymer blend in the coating composition is above or well above room temperature. In some exemplary embodiments, if P2 and/or P3 comprise rubbery elastomers, the T_{g} may be below room temperature so the coating is relatively soft and flexible. Drying of the coating at standard ambient temperature and pressure (IUPAC) may be carried out for 0.5 to 1 hour.

### Example 1

### Preparation of Polyurethane-Polyacrylic Blended Dispersion

Synthesis. Various polyurethane and polyurethane-acrylate dispersions known by trade names Bayhydrol UH 2593/1, Bayer Material Science and NeoRez R-2180, DSM NeoResins and Bayhydrol UH 240, Bayer Material Science and Bayhydrol, and NeoPac E-122, DSM NeoResins, and Bayhydrol A 2651, Bayer Material Science were mixed by 5 minute-mild stirring at room temperature. Optionally, a small amount of co-solvents such as butoxydiglycol, butyl glycol, glycol ethyl ether and diethylene glycol ethyl ether, may be added into the mixture of polymer dispersions. The mixture is stirred at 300 rpm for 5 minutes. Then, some additives such as defoamers, leveling agents, and organic wax emulsion, in addition, a thickener that is based on polyurethane, were incorporated into the mixture with the mild agitation. The agitation speed was 300 to 500 rpm for 5 minutes to form a homogeneously blended coating composition. The MFFT of the coating compositions were measured and ranged from 8° C. to 21° C. Polymer particle sizes of 60 nm and 200 nm were used. The solid weight content of the sample coating compositions were kept constant at 40%.

Surface Coating Process.

Prior to coating operation, the floor surface was cleaned to remove the dust and stain on the floor. The amount of coating composition generally depends on the thickness of coated film required on the floor. To achieve a 0.15 mm coating thickness over a tile area of 667 mm² or roughly 26 mm by 26 mm, 0.1 Liters of coating binder was used. For coating, the coating composition is poured onto the floor tile and coated uniformly with a brush and/or roller. The floor surface was allowed to dry through ambient air drying at room temperature for 0.5 to 2 hours. The drying time may take longer, depending on the thickness of coated film. The appearance of the floor surface and the structures of crack-patterns were observed by optical spectroscope (OM).

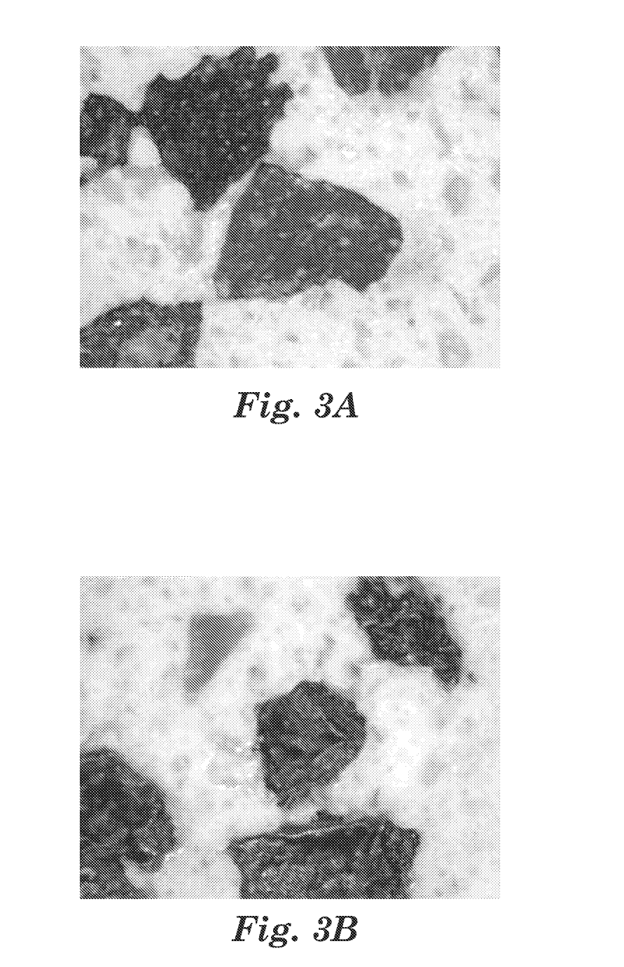

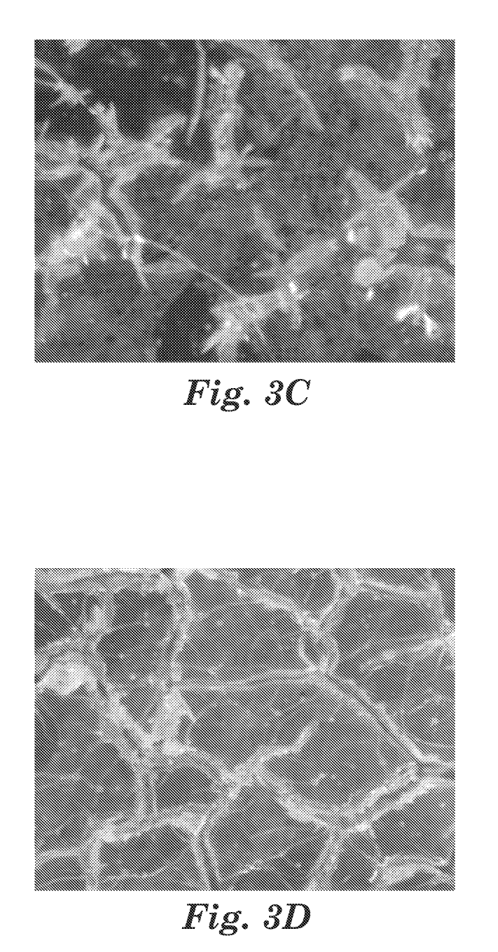

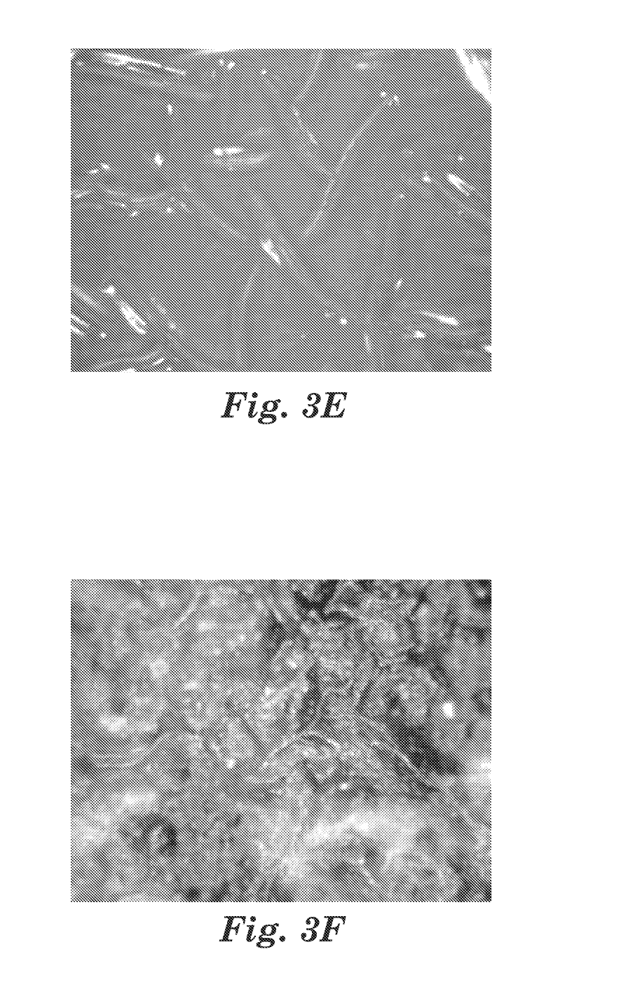

FIG. 3 shows various surfaces coated with coatings prepared in Example 1, each showing various crack patterns, namely (a) pure vinyl tile surface without coating; (b) Scotchgard Stone Protector™ coating; (c) small sized fine crack-pattern by flexible polymer dispersion with low elastic modulus; (d) large sized periodic crack-pattern by stiff polymer dispersion with high elastic modulus; (e) large sized radial crack-pattern with the mixture of both (c) and (d) polymer dispersions; (f) 3M Safety Walk™ Slip-Resistant Tape. In the case of coating with Scotchgard™ Stone Protector, there was no crack-formation on the floor surface and the surface had a crack-free appearance. Conversely, a number of polymer (polyurethane) dispersions once applied and dried demonstrated crack-formation on the surface of the coated films. It was found that those dispersions generally had high MFFT. Flexible polymer films with low modulus showed small-sized, fine crack-patterns where the cracks were disconnected and separated (FIG. 3C). On the other hand, stiff polymer dispersions with high elastic modulus generally displayed the large-sized and well connected crack-patterns (refer FIG. 3D). Where the base coating solution comprised a mixture of both flexible and stiff polymer dispersions, a “mixed” crack pattern was generally observed (FIG. 3E). All crack-patterned films have similar surface structures to 3M Safety Walk™ Slip-Resistant Tape (FIG. 3F). In general the crack-patterns associated with the polyurethane test mixtures increased the slip resistance of the floor surface commensurate with 3M Safety Walk™ Tapes.

Performance Evaluation.

To determine the slip resistance, gloss and peel-off properties of the coated surface, floor surfaces with varying crack-patterns were evaluated on a vinyl tile as the test floor substrate. Slip resistance was measured by British Pendulum Slip Resistance Tester under wet condition. Gloss was measured by Glossmeter (20° and 60°) from Munro Instruments Ltd. The ability to remove the surface film was tested for peel strength with an Instron tester and tear properties of the coated film was visually evaluated during the peeling operation. Reference surfaces comprised 1) untreated vinyl tile (Comparative Example 1), 2) vinyl tile treated with 3M Scotchgard Stone Protector™ coating (Comparative Example 2), and 3) vinyl tile with 3M Safety Walk™ Slip-Resistant Tape (Comparative Example 3). A flexible polyurethane dispersion coating was used for Test Sample 1, and a stiff polyurethane dispersion coating was used for Test Sample 2, and a mixture of flexible and stiff polyurethane dispersions was used for Test Sample 3.

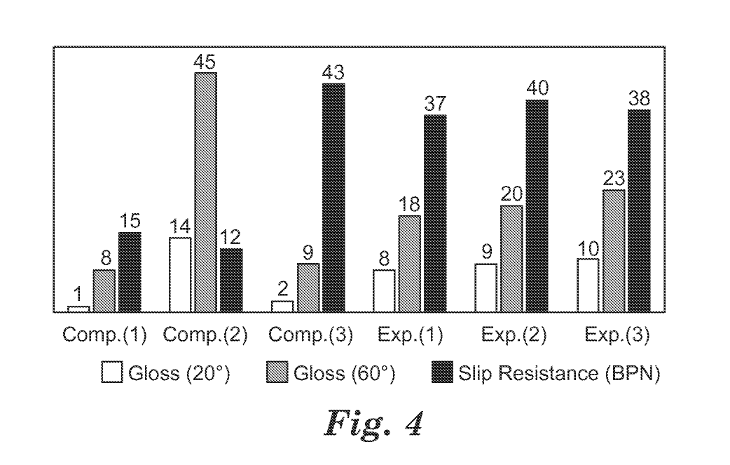

The experimental results obtained from the performance evaluation of surfaces coated with different coatings were tabulated in Table 1 and presented graphically in FIG. 4. All crack-patterns on the coated films increased the slip resistance of coatings. Table 1 shows a table of test results.

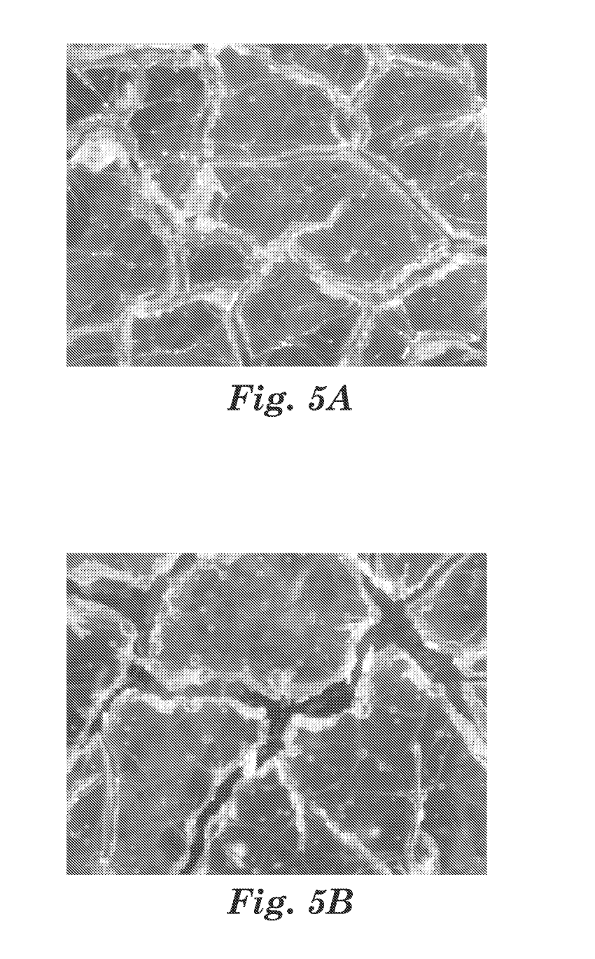

However it was noted that polyurethane dispersions that produced stiff surface coatings, as in the case of Test Sample 2, were easily broken during the slip resistance testing due to the poor impact resistance of those films. The sharp decrease in slip resistance was due to the breakage of the coating during the slip resistance tests. FIG. 5 shows the split and broken crack patterns after slip resistance testing when tests were carried out on conventional polyurethane coatings that were stiff and somewhat brittle. Coatings of the present disclosure, as exemplified by Examples 3 and 4, maintained consistent crack-patterning even after slip resistance testing. Hence, flexible polymers with the low elastic modulus were desirable for producing durable cracking on the surface of coatings.

TABLE 1
Table of test results obtained from performance evaluation
of surfaces coated with different coatings.

| | | | | | Slip | |
|---|---|---|---|---|---|---|
| | MFFT* | % Solid | Particle | Viscosity | Resistance | Gloss |
| Example | (° C.) | Content | Size (nm) | (mPa · s) | (BPN) | (20°/60°) |
| Comparative 1 | N/A | N/A | N/A | N/A | 15 | 1/8 |
| Comparative 2 | — | 13.0 | ~150 | 50 | 12 | 14/45 |
| Comparative 3 | N/A | N/A | N/A | N/A | 43 | 2/9 |
| Test Sample 1 | 8 | 40.0 | 200 | 250 | 37 | 8/18 |
| Test Sample 2** | 21 | 40.0 | 60 | 250 | 40 | 9/20 |
| Test Sample 3 | ~15 | 40.0 | 60 (50%) | 250 | 38 | 10/24 |
| | | | 200 (50%) | | | |

### Example 2

### Preparation of Coatings with Primer Layer

In this example, various coating compositions were prepared and a primer layer was introduced in this example as an intermediate layer between the peelable coating and the floor surface. Additionally, these compositions comprised particulate additives selected from polypropylene particles that are used as surface friction enhancers. The coating compositions were formed using polyurethane and polyurethane-acrylate dispersions known by trade names Bayhydrol UH 2593/1 and NeoRez R-2180 were used in the ratio of 72:28 wt %. The same peelable coating was used on each different primer coating layer. Optionally, a small amount of co-solvents such as butoxydiglycol, butyl glycol, glycol ethyl ether and diethylene glycol ethyl ether, may be added into the mixture of polymer dispersions. The mixture is stirred at 300 rpm for 5 minutes. Then, some additives such as defoamers, leveling agents, and organic wax emulsion, in addition, a thickener that is based on polyurethane, were incorporated into the mixture with the mild agitation. Lastly, micron-sized polypropylene granules were added. The agitation speed was 300 to 500 rpm for 5 minutes to form a homogeneously blended coating composition.

Various primers were tested in this example. In Comparative Example 1, no primers were used. In Example 1, 3M Scotchgard Vinyl Protector™ product, an acrylic polymer, was used as primer. In Example 2, 3M Spangle Floor Finish™″ product, also an acrylic polymer, was used as primer. In Example 3, 3M Scotchgard Vinyl Protector™ and a fluorine modified water based acrylic polymer, namely DSM AF-10™, was used as primer. In Example 4, 3M Scotchgard Vinyl Protector™ was used as primer, along with a very thin peelable coating layer (0.13 mm) In Example 5, paraffin wax was used as a primer coat layer. In Example 6, polypropylene was used as a primer layer.

For the coating process, prior to coating operation, the floor surface was cleaned to remove the dust and stain on the floor. The primer was coated onto the floor surface using a mop and is dried at room temperature for less than 30 minutes. To achieve a 0.02 mm coating thickness over a tile area of 1.0 m², 0.02 Liters of coating binder was used. For peelable coating, the coating composition is poured onto the primer coated floor tile and coated uniformly with a brush and/or roller. The floor surface was allowed to dry through ambient air drying at room temperature for 0.5 to 1 hours. The drying time may take longer, depending on the thickness of coated film. The amount of coating composition generally depends on the thickness of coated film required on the floor. To achieve a 0.15 mm coating thickness over a tile area of 667 cm² or roughly 26 cm by 26 cm, 0.1 Liters of coating binder was used.

Table 2 tabulates the various coating and primer layer compositions in this example and test results obtained from performance evaluation of the coated surfaces.

TABLE 2

| | | Peelable | | | | |
|---|---|---|---|---|---|---|
| | | layer | Polypropylene | Slip | | Peel |
| | Primer | thickness | Particle % | Resistance | Gloss | Strength |
| Example | Layer | (mm) | Content | (BPN) | (60°) | (N/25 mm) |
| Comparative 1 | N/A | 0.28 | 2.0 | 46 | 43 | 13.5 |
| Example 1 | Acrylics | 0.25 | 2.0 | 45 | 36 | 0.5 |
| | polymer (1) | | | | | |
| Example 2 | Acrylics | 0.26 | 2.0 | 45 | 42 | 4.5 |
| | polymer (2) | | | | | |
| Example 3 | Acrylics | 0.24 | 2.0 | 44 | 39 | 2.4 |
| | polymer + | | | | | |
| | fluorine | | | | | |
| | modified | | | | | |
| | polymer | | | | | |
| Example 4 | Acrylics | 0.13 | 2.0 | 44 | 38 | 0.7 |
| | polymer (1) | | | | | |
| Example 5 | Paraffin wax | 0.27 | 2.0 | 44 | 30 | 0.4 |
| Example 6 | Polyethylene | 0.25 | 2.0 | 45 | 40 | 1.0 |

Peel strength test method was in accordance with a 90° peel test method. As can be seen from the above test results, Comparative Example 1 displayed the highest peel strength when coated directly on the floor surface. In the other examples, when a primer layer was present, the coatings displayed appropriately low peel strength, which means, primer coat layer enables easy peelability of the coating layer. The use of a fluorinated polymer as primer layer achieved a peel strength that is within a desired range for an adequately adhered coating that is also easily peelable.

### Example 3

### Preparation of Polyurethane-Polyvinyl Acetate Blended Dispersion

Synthesis. Polyurethane dispersion (Bayhydrol UH 2593/1, Bayer Material Science) and polyvinyl acetate dispersion (Acropol 63893, Nuplex Industries Ltd) were mixed by 5 minute-mild stirring at room temperature. Optionally, a small amount of co-solvents such as butoxydiglycol, butyl glycol, glycol ethyl ether and diethylene glycol ethyl ether, may be added into the mixture of polymer dispersions. The mixture is stirred at 300 rpm for 5 minutes. Additives such as defoamers, leveling agents, and organic wax emulsion, in addition, a thickener that is based on polyurethane, were incorporated into the mixture with the mild agitation. The agitation speed was 300 to 500 rpm for 5 minutes until a homogeneous coating composition was obtained. The coating composition was applied on a floor surface and left to dry to form a textured surface. The coating formed was flexible and soft, and had a very smooth and cushioned feel.

### Example 4

### Preparation of Polyurethane-Polyurethane Blended Dispersion

Synthesis.

A first polyurethane dispersion (Bayhydrol UH 2593/1, Bayer Material Science) and second polyurethane dispersion (NeoRez R-4000, DSM NeoResins) were mixed by 5 minute-mild stirring at room temperature. Optionally, a small amount of co-solvents such as butoxydiglycol, butyl glycol, glycol ethyl ether and diethylene glycol ethyl ether, may be added into the mixture of polymer dispersions. The mixture is stirred at 300 rpm for 5 minutes. Then, some additives such as defoamers, leveling agents, and organic wax emulsion, in addition, a thickener that is based on polyurethane, were incorporated into the mixture with the mild agitation. The agitation speed was 300 to 500 rpm for 5 minutes until a homogeneous coating composition was obtained. The coating composition was applied on a floor surface and left to dry to form a textured surface. The coating formed displayed film hardness, and was not transparent, but some hazy (a mild white) colored film.

### Example 5

### Preparation of Polyurethane-(Polyacrylate) Blended Dispersion

Synthesis. Polyurethane dispersions (NeoRez R-1004, DSM NeoResins) and polyacrylate dispersion (Bayhydrol A 2651, Bayer Material Science) were mixed by 5 minute-mild stirring at room temperature. Optionally, a small amount of co-solvents such as butoxydiglycol, butyl glycol, glycol ethyl ether and diethylene glycol ethyl ether, may be added into the mixture of polymer dispersions. The mixture is stirred at 300 rpm for 5 minutes. Then, some additives such as defoamers, leveling agents, and organic wax emulsion, in addition, a thickener that is based on polyurethane, were incorporated into the mixture with the mild agitation. The agitation speed was 300 to 500 rpm for 5 minutes until a homogeneous coating composition was obtained. The coating composition was applied on a floor surface and left to dry to form a textured surface. Similar to Example 3, the coating formed displayed film hardness, and was not transparent, but some hazy (a mild white) colored film.

### Example 6

### Preparation of Polyurethane-Polyacrylate Blended Dispersion

Synthesis.

Polyurethane dispersions (Bayhydrol UH 240, Bayer Material Science) and polyacrylate dispersion (Bayhydrol A 2651, Bayer Material Science) were mixed by 5 minute-mild stirring at room temperature. Optionally, a small amount of co-solvents such as butoxydiglycol, butyl glycol, glycol ethyl ether and diethylene glycol ethyl ether, may be added into the mixture of polymer dispersions. The mixture is stirred at 300 rpm for 5 minutes. Then, some additives such as defoamers, leveling agents, and organic wax emulsion, in addition, a thickener that is based on polyurethane, were incorporated into the mixture with the mild agitation. The agitation speed was 300 to 500 rpm for 5 minutes until a homogeneous coating composition was obtained. The coating composition was applied on a floor surface and left to dry to form a textured surface. Similar to Example 3 and 4, the coating formed displayed film hardness, and was not transparent, but some hazy (a mild white) colored film.

### Example 7

### Commercially Available Floor Finish as Release Coating

Synthesis.

Various polyurethane and polyurethane-acrylate dispersions known by trade names as Bayhydrol UH 2593/1 (Bayer Material Science), NeoRez R-2180 (DSM NeoResins), Bayhydrol UH 240 (Bayer Material Science), NeoPac E-122 (DSM NeoResins), and Bayhydrol A 2651 (Bayer Material Science) were mixed under mild stirring at room temperature for 5 minutes. Some additives such as defoamers, leveling agents, and organic wax emulsion were then incorporated into the mixture under the mild agitation. Micron-sized polypropylene granules were then added and the agitation speed was increased to 300 to 500 rpm for 5 minutes. Finally, a small amount of co-solvents such as butoxydiglycol, butyl glycol, glycol ethyl ether, and diethylene glycol ethyl ether was added slowly into the mixture of polymer dispersions with stirring at 300 rpm for 5 minutes to form a homogeneously blended coating composition, with a solid weight content of the solution around 40%.

Tile Coating Process.

An Imperial texture standard Excelon vinyl composition tile from Armstrong Inc. was stripped with 3M™ Floor Stripper. 2 grams of the floor finish product as indicated was applied to the stripped side of the tile with a gauze and the coating was dried under ambient conditions for 30 minutes. A second layer of 2 grams of the floor finish product as indicated was applied on top of above coating with a gauze and the coating was dried under ambient conditions for either 30 minutes or 7 days as indicated. Then 40 grams of the first layer of the anti-slip floor coating solution as indicated in Table 3 was applied uniformly to the coated tile with a 9 inch wide Scotchgard™ Floor Protector Applicator Pad from 3M and the coating was dried under ambient conditions for 30 minutes to 2 hours until it was dry to touch. A second layer of 35 grams of the anti-slip floor coating solution as indicated in Table 3 was coated on top of the coated tile with the applicator and the final coating was dried under ambient conditions for 24 hours to be evaluated.

Evaluation.

The gloss at 60 degrees was tested using a BYK-Gardner micro-tri-Gloss meter as an average of 5 uniformly spaced locations on the coated tile. The static coefficient of friction (static COF) on dry tiles was measured with a James Machine according to ASTM D2047-82. The peel strength of the anti-slip floor coating from the rest of the coated tile was measured with an Instron at 90 degree peel. The failure mode of the peeling was recorded as either “clean delamination” or “cohesive failure”, followed with the indication of the interface where the peel occurred. “Clean delamination” indicated clean peel of the coating with no residual left on the rest of the tile, while “cohesive failure” indicated visible residual left on the rest of the tile. The interface where the peel occurred was indicated with either between “FC” (floor finish coating) and tile, or between “AS” (anti-slip coating) and “FC”. The thickness of the peeled film was measured with a thickness gauge.

Seven floor finish products as indicated in Table 3 were evaluated underneath the anti-slip floor coating as described above. The second layer of the floor finish coating was dried for 30 minutes prior to the first layer of the anti-slip floor coating. The results showed that the anti-slip floor coating had similar anti-slip properties and glossy appearance, regardless of the floor finish product underneath. In comparison, the peelability of the anti-slip floor coating film was highly dependent on the floor finish product underneath. In Comparative examples 1 to 5, the anti-slip floor coating film could not be peeled off cleanly from the floor finish product such as Spangle™ floor finish, Scotchgard™ Low Maintenance 25 Floor Finish, Scotchgard™ Resilient Floor Protector, High Mileage® Floor Finish, and Vectra® Floor Finish, the film either tore or left residual on the rest of the coated tile. On the other hand, in Inventive examples 1 and 2, the anti-slip floor coating film could be peeled cleanly from Scotchgard™ Vinyl Floor Protector and Castleguard® Floor Finish with relatively low peel strength.

### Example 8

### Commercially Available Floor Finish as Release Coating

The release property of the anti-slip floor coating from the coated floor is highly dependent on the drying time (i.e., the extent of curing) of the floor finish product prior to the application of the anti-slip floor coating. With similar testing procedures as those described in Example 7, Table 4 shows the comparison of the drying time between 30 minutes and 7 days with selected floor finish products, where the anti-slip floor coating gave similar anti-slip property and glossy appearance regardless of the floor finish product underneath and its drying time. For example, Scotchgard™ Low Maintenance 25 Floor Finish and Scotchgard™ Resilient Floor Protector required extensive drying up to 7 days to allow clean peel of the coating from the vinyl tile in Inventive example 3 and 4, in comparison to the Comparative examples 2 and 3 where cohesive failure occurred upon peeling with only 30 minutes drying. On the other hand, 30 minutes drying was sufficient for Scotchgard™ Vinyl Floor Protector and Castleguard® Floor Finish to give clean peeling of the anti-slip floor coating in Inventive examples 1 and 2, while 7 day drying led to cohesive failure upon peeling in Comparative examples 6 and 7.

### Example 9

### Addition of a Releasing Agent to the Floor Finish Product

The release property of the anti-slip floor coating from the floor finish product can also be modified with addition of a releasing agent into the floor finish product, such as HFPO (hexafluoropropylene oxide, Sigma-Aldrich). With similar testing procedures as those described in Example 7, Table 5 shows that, while cohesive failure occurred in Comparative example 1, the addition of 1% by weight of HFPO into Spangle™ floor finish led to clean peel of the anti-slip floor coating in Inventive example 5 without affecting the slip resistance of the anti-slip floor coating.

### Example 10

### Addition of a Releasing Agent to the Anti-Slip Floor Coating Solution

The release property of the anti-slip floor coating can also be modified with a releasing agent such as fluorinated polyurethanes (FPU-1) without adversely changing its anti-slip performance. The FPU-1 polyurethane dispersion was prepared as follows. A 500 mL four-necked round bottom flask equipped with a mechanical stirrer, thermometer, condenser and nitrogen inlet was charged with 51.07 g Desmodur C 2100 polyol (Mw=1000; from Bayer) and 44.42 g H12MDI (Desmodur W from Bayer). The polyaddition reaction was carried out under stirring at 78° C. in the presence of dibutyltin dilaurate of 0.01 wt % based on the total solid (Sigma-Aldrich). After 1 hour of reaction, 4.5 g dimethylol propionic acid (DMPA; from TCI) and 20 gram methyl ethyl ketone (MEK) were added. Then the reaction was carried out for about 2 hours until DMPA was dissolved to form a homogenous solution. The NCO content of the prepolymers was determined by standard dibutylamine back titration method. Upon obtaining the theoretical NCO value, the chains were extended by adding 1,4-butendiol of 3.06 g (1,4-BDO; from J. T. Baker) and fluorinated C4 diol of 0.57 g, and allowed to react for 1.5 hours to form polyurethanes prepolymer, then terminated with a fluorinated C4 mono alcohol of 0.53 g for 1 hour. The resulting prepolymers were cooled to 40° C. and neutralized by the addition of triethylamine (3.4 g, from EMD Chemicals) for 30 minutes. Aqueous dispersions were accomplished by slowly adding water to polyurethane prepolymer with vigorous stirring. Once the prepolymer was dispersed, the ethylene diamine (from Alfa Aesar) of 2.65 g in 5.0 g water was slowly added for further chain extension under the stirring. MEK was removed at 40° C. on a rotary evaporator, resulting in a polyurethane dispersion with a solid content of 35% by weight. The anti-slip floor coating solution was prepared with incorporation of FPU-1 as described in Example 7. With similar testing procedures as those described in Example 7, Table 6 shows that with either Scotchgard™ Vinyl Floor Protector or Castleguard® Floor Finish underneath, the fluoro component in the anti-slip floor coating formulation B did not affect the anti-slip performance and the gloss appearance of the coating. However, the incorporation of the FPU-1 into the anti-slip floor coating improved its peelability significantly in Inventive examples 6 and 7.

In yet a further aspect, coated articles are provided. Coatings described herein are suitable for coating any article or any surface where protection, cleanliness, gloss, scuff resistance, and/or slip resistance is desirable. Such surfaces include furniture, food preparation surfaces, walls, stalls, counters, bathroom fixtures, etc, and in particular, floors that require slip resistance. The surfaces to be coated may be made from a large variety of materials including, but not limited to, acrylic tiles, ceramic tiles, marble, stone, metal and wooden laminate, terrazzo, ceramic, linoleum, plastics, rubber, concrete, vinyl composition tiles (“VCT”) and glass. Advantageously, the coatings are also applicable to articles or surfaces with pre-existing coatings, such as acrylic or polyurethane coatings, which may have applied previously and have since been worn out through use. The pre-existing coating does not need to be removed before the coatings of the present disclosure are conveniently applied to provide surface protection, cleanliness, gloss, scuff resistance, and/or slip resistance.

Although the present invention has been described with particular reference to preferred embodiments illustrated herein, it will be understood by those skilled in the art that variations and modifications thereof can be effected and will fall within the scope of this invention as defined by the claims thereto now set forth herein below.

TABLE 3
Evaluation of floor finish products as release coating under the anti-slip floor coating.

| | | | | Peel | | Gloss | Film |
|---|---|---|---|---|---|---|---|
| | | | | Strength | Static | at 60 | thickness |
| Example | Floor finish product | Supplier | Peel-off | (lb/F) | COF | degree | (mm) |
| Comparative-1 | Spangle ™ floor finish | 3M | cohesive failure on AS/FC | 0.85 | 0.75 | 40 | 0.32 |
| | | | and FC/tile | | | | |
| Comparative-2 | Scotchgard ™ Low Maintenance | 3M | cohesive failure on AS/FC | 0.67 | 0.74 | 37 | 0.35 |
| | 25 Floor Finish | | | | | | |
| Comparative-3 | Scotchgard ™ Resilient Floor | 3M | cohesive failure, tear the film | 2.71 | 0.73 | 38 | 0.26 |
| | Protector | | | | | | |
| Comparative-4 | High Mileage ® Floor Finish | Diversey | cohesive failure on AS/FC | 1.26 | 0.72 | 37 | 0.32 |
| Comparative-5 | Vectra ® Floor Finish | Diversey | cohesive failure on AS/FC | 0.67 | 0.76 | 37 | 0.27 |
| Inventive-1 | Scotchgard ™ Vinyl Floor Protector | 3M | clean delamination on AS/FC | 0.23 | 0.72 | 46 | 0.27 |
| Inventive-2 | Castleguard ® Floor Finish | Buckeye | clean delamination on AS/FC | 0.66 | 0.72 | 34 | 0.29 |
| | | International | | | | | |

TABLE 4
Performance dependence on the drying time between the second layer of floor finish product and the first layer of the anti-slip floor coating.

| | | Drying time between the | | | | | | |
|---|---|---|---|---|---|---|---|---|
| | | second layer of the floor | | | | | | |
| | | finish product and the | | | Peel | | Gloss | Film |
| | | first layer of the anti-slip | | | Strength | Static | at 60 | thickness |
| Example | Floor finish product | floor coating | | Peel-off | (lb/F) | COF | degree | (mm) |
| Comparative-2 | Scotchgard ™ Low Maintenance 25 | 30 | minutes | cohesive failure on AS/FC | 0.67 | 0.74 | 37 | 0.35 |
| | Floor Finish | | | | | | | |
| Inventive-3 | Scotchgard ™ Low Mantenance 25 | 7 | days | clean delamination on FC/tile | 0.34 | 0.72 | 31 | 0.29 |
| | Floor Finish | | | | | | | |
| Comparative-3 | Scotchgard ™ Resilient Floor | 30 | minutes | cohesive failure, tear the film | 2.71 | 0.73 | 38 | 0.26 |
| | Protector | | | | | | | |
| Inventive-4 | Scotchgard ™ Resilient Floor | 7 | days | clean delamination on FC/tile, | 1.83 | 0.73 | 40 | 0.34 |
| | Protector | | | high peel strength | | | | |
| Inventive-1 | Scotchgard ™ Vinyl Floor | 30 | minutes | clean delamination on AS/FC | 0.23 | 0.72 | 46 | 0.27 |
| | Protector | | | | | | | |
| Comparative-6 | Scotchgard ™ Vinyl Floor | 7 | days | cohesive failure on AS/FC | 0.59 | 0.70 | 37 | 0.34 |
| | Protector | | | | | | | |
| Inventive-2 | Castleguard ® Floor Finish | 30 | minutes | clean delamination on AS/FC | 0.66 | 0.72 | 34 | 0.29 |
| Comparative-7 | Castleguard ® Floor Finish | 7 | days | cohesive failure on AS/FC | 1.15 | 0.72 | 40 | 0.24 |

TABLE 5
Performance dependence on the releasing agent HFPO in the
floor finish product.

| | | | | Peel | |
|---|---|---|---|---|---|
| | Floor finish | | | Strength | Static |
| Example | product | HFPO | Peel-off | (lb/F) | COF |
| Comparative-1 | Spangle ™ | no | cohesive failure on | 0.85 | 0.75 |
| | floor finish | | AS/FC and FC/tile | | |
| Inventive-5 | Spangle ™ | yes | clean delamination | 1.13 | 0.70 |
| | floor finish | | on AS/FC | | |

TABLE 6
Performance dependence on the releasing agent FPU-1 in the anti-slip floor coating

| | | | | Peel | | Gloss | Film |
|---|---|---|---|---|---|---|---|
| | | FPU-1 | | Strength | Static | at 60 | thickness |
| Example | Floor finish product | present? | Peel-off | (lb/F) | COF | degree | (mm) |
| Comparative-6 | Scotchgard ™ Vinyl Floor Protector | No | cohesive failure on AS/FC | 0.59 | 0.70 | 37 | 0.34 |
| Inventive-6 | Scotchgard ™ Vinyl Floor Protector | Yes | clean delamination on AS/FC | 0.60 | 0.74 | 30 | 0.29 |
| Comparative-7 | Castleguard ® Floor Finish | No | cohesive failure on AS/FC | 1.15 | 0.72 | 40 | 0.24 |
| Inventive-7 | Castleguard ® Floor Finish | Yes | clean delamination on AS/FC | 0.53 | 0.72 | 37 | 0.25 |

1. A coating for a surface, comprising
a polymer blend of polyurethane as a major component and at least one other polymer P2 having in comparison to polyurethane
a higher peel strength to the surface to be coated,
a higher percent elongation at break when cured, and
a lower glass transition temperature,
the polymer blend having been cured to form a peelable and flexible layer having a textured surface.

2. The coating of claim 1, wherein the polymer blend excludes particulate additives larger than 30 μm.

3. The coating of claim 1, further comprising a polymer P3 having in comparison to P2 either one of a higher peel strength to the surface to be coated, a higher percent elongation at break when cured, or a lower glass transition temperature,

4. The coating of claim 1, wherein polymer P2 and/or polymer P3 is selected from an adhesive polymer having a peel strength (ASTM D1000) of between 20 N/25 mm to 25N/25 mm on the surface to be coated.

5. The coating of claim 1, wherein polymer P2 and/or polymer P3 is selected from an elastomeric polymer having a percent elongation at break of between 200% to 1000%.

6. The coating of claim 1, wherein polymer P2 and/or polymer P3 has a glass transition temperature of less than 10° C.

7. The coating of claim 1, wherein polymer P2 and/or polymer P3 is selected from the group consisting of:
polyesters, polyurethane-acrylates (PUA), polyacrylates, polyvinyl alcohol, polyvinyl acetate, and acrylate modified polyolefins.

8. The coating of claim 7, wherein the coating comprises 50% to 90% by weight of polyurethane and 10% to 50% by weight of polymer P2.

9. The coating of claim 7, wherein the coating comprises 60% to 90% by weight of polyurethane, 5% to 20% by weight of polymer P2, and 5% to 20% by weight of polymer P3.

10. The coating of claim 1, wherein the textured surface has a root-mean-square (RMS) surface roughness of between 1 μm to 5 μm.

11. The coating of claim 1, wherein the textured surface comprises cracks on the surface of the cured polymer blend.

12. The coating of claim 1, wherein the glass transition temperature of the polymer blend is above 30° C.

13. The coating of claim 1, wherein the polymer blend is cured by drying a waterborne dispersion containing the polymer blend, the waterborne dispersion having a minimum film formation temperature of 30° C. or less.

14. The coating of claim 1, further comprising a primer layer arranged between said coating and the surface.

15. The coating of claim 14, wherein the primer layer comprises a release coating for decreasing the adhesion of the coating to the surface.

16. The coating of claim 15, wherein the release coating comprises a surface active agent.

17. The coating of claim 14, wherein the primer layer comprises an adhesion promoter for increasing the adhesion of the coating to the surface.

18. The coating of claim 14, wherein the primer comprises at least one of a fluorinated compound, an acrylic polymer, a polyurethane, a polyurethane acrylate, a silicone compound, a silicone modified polymer, paraffin wax, polypropylene wax, polyethylene wax, and mixtures thereof.

19. The coating of claim 1, further comprising a low surface energy additive.

20. (canceled)

21. A coating composition, comprising:
water-borne polymer dispersion that comprises polyurethane as a major component and at least one other polymer P2, polymer P2 having in comparison to polyurethane
a higher peel strength to the surface to be coated,
a higher percent elongation at break when cured, and
a lower glass transition temperature,
the polymer dispersion being curable to form a peelable and flexible layer having a textured surface.

22-32. (canceled)

33. A method of coating a surface, comprising the steps of:
providing a coating composition comprising a water-borne polymer dispersion that comprises polyurethane as a major component and at least one other polymer P2, polymer P2 having in comparison to polyurethane
a higher peel strength to the surface to be coated,
a higher percent elongation at break when cured, and
a lower glass transition temperature,
the polymer dispersion being curable to form a peelable and flexible layer having a textured surface,
applying the coating composition over the surface to be coated,
and
curing the coating composition to form a peelable and flexible layer having a textured surface.

34-40. (canceled)
